(19) United States
(12) Patent Application Publication
(10) Pub. No.: US 2026/0031731 A1
(43) Pub. Date: Jan. 29, 2026

(54) ACU MAIN LINE VOLTAGE DETECTION METHOD WITH FLYBACK ISOLATED BASED SMPS

(71) Applicant: WHIRLPOOL CORPORATION, BENTON HARBOR, MI (US)

(72) Inventors: Eduardo Maldaun Barreto, Joinville (BR); Lorenzo Mercatali, Varese (IT)

(73) Assignee: WHIRLPOOL CORPORATION, BENTON HARBOR, MI (US)

(21) Appl. No.: 18/781,517

(22) Filed: Jul. 23, 2024

(51) Int. Cl. H02M 3/335; H02M 1/00; H02M 1/32; H02M 1/36

(52) U.S. Cl. CPC H02M 3/33515; H02M 1/0009; H02M 1/32; H02M 1/36

(57) ABSTRACT

A detection system for a power supply of an appliance includes a flyback converter, a detection circuit, and a controller. The flyback converter includes an isolation transformer, a switch for controlling current through a primary coil of the isolation transformer, and a power diode connected to a secondary coil of the isolation transformer at a secondary node to provide rectified power to the controller. The detection circuit includes a sensing diode having an orientation that is opposite an orientation of the power diode. The sensing diode electrically connects the secondary node with the controller to provide a detection signal to the controller.

### BACKGROUND OF THE DISCLOSURE

Isolated flyback converters may be used in appliances to supply microcontrollers with a DC output voltage that is isolated from a main AC input voltage.

### SUMMARY OF THE DISCLOSURE

An aspect of the present disclosure is a detection system for a power supply of an appliance. The detection system includes a flyback converter, a detection circuit, and a controller. The flyback converter includes: 1) an isolation transformer, 2) a switch for controlling current through a primary coil of the isolation transformer, and 3) a power diode connected to a secondary coil of the isolation transformer at a secondary node to provide rectified power to the controller. The detection circuit includes a sensing diode having an orientation that is opposite an orientation of the power diode. The sensing diode electrically connects the secondary node with the controller to provide a detection signal to the controller.

The detection circuit may further include a voltage divider interposing the sensor diode and the controller to condition the detection signal.

The controller may be configured to determine if the appliance is miswired based, at least in part on the detection signal.

The controller may be configured to read an analog voltage if negative current is induced in the secondary coil of the isolation transformer to determine that the appliance is miswired.

The detection circuit may be configured to cancel a positive portion of a signal across the secondary coil of the isolation transformer, whereby the controller reads only a positive portion of a signal across the secondary coil of the isolation transformer.

The detection system may be utilized in an appliance that includes a housing and an electric power system disposed inside the housing, and an electrical line having a plug that is configured to engage an electrical socket to electrically connect the electrical power system to a selected one of a 110 volt AC power system and a 220 volt AC power system.

The flyback converter may include a primary side that is electrically coupled to a secondary side by the isolation transformer, wherein the primary side is configured to be coupled to a selected one of a 110 volt AC power system and a 220 volt AC power system. The controller may comprise a microcontroller, and the flyback converter may be configured to supply the microcontroller with 5 volt DC electrical power.

The microcontroller may be operably coupled to a user interface of the appliance, and the microcontroller may be configured to cause the user interface to provide an audio and/or visual indication that the appliance is miswired if the microcontroller determines that the electrical power system is not electrically connected to the selected one of a 110 volt AC power system and a 220 volt AC power system as required for proper operation of the appliance.

The appliance may be selected from a group consisting of a washing machine for laundering clothes, a clothes dryer, an oven having an electrical heating element, a microwave oven, and a range that is configured to heat pots and pans.

Another aspect of the present disclosure is a power supply including a flyback converter, wherein the flyback converter includes an isolation transformer coupling a primary side defining an input voltage to a secondary side defining an output voltage. The primary side is configured to be coupled to an AC power source. The primary side is operably connected to a drive circuit, the drive circuit controlling a switch to cause the switch to change between ON and OFF states, thereby causing current to flow through a primary coil of the transformer at a target frequency and causing positive and negative output current and output voltage in a secondary coil of the transformer on the secondary side. The power supply further includes a controller operably coupled to first and second nodes of the secondary coil by first and second lines, respectively, wherein the first line includes a power diode whereby positive voltage is supplied to the controller. The power supply further includes an output capacitor interconnecting the first and second lines, and a detection circuit operably interconnecting the controller to the secondary coil. The detection circuit includes a sensing diode having an orientation that is opposite an orientation of the power diode, and the sensing diode electrically connects the first node with the controller to provide a detection signal to the controller.

The detection circuit may further include a voltage divider interposing the sensing diode and the controller to condition the detection signal.

The controller may be configured to determine if the appliance is miswired based, at least in part, on the detection signal.

The controller may be configured to read an analog voltage if negative current is induced in the secondary coil of the isolation transformer to thereby determine that the appliance is miswired.

The detection circuit may cancel a positive portion of a signal across the secondary coil of the isolation transformer whereby the controller reads only a positive portion of a signal across the secondary coil of the isolation transformer.

Another aspect of the present disclosure is a method of measuring an AC input voltage to a flyback converter of a power supply of an appliance utilizing a detection circuit. The method includes operably coupling a power diode to a secondary coil of an isolation transformer of the flyback converter at a secondary node to provide rectified power to a controller. The method further includes operably coupling a sensing diode with the secondary node and with the controller, wherein the sensing diode is coupled in an orientation that is opposite an orientation of the power diode, whereby the sensing diode provides a detection signal to the controller. The method further includes causing the controller to read the AC input voltage utilizing the detection signal.

The detection circuit may further include a voltage divider interposing the sensing diode and the controller. The method may include conditioning the detection signal utilizing the voltage divider.

The method may include configuring the controller to determine if the appliance is miswired based, at least in part, on the detection signal.

The method may include configuring the controller to read an analog voltage if negative current is induced in the secondary coil of the isolation transformer to determine that the appliance is miswired.

The method may include utilizing the detection circuit to cancel a positive portion of a signal across the secondary coil of the isolation transformer whereby the controller reads only a positive portion of a signal across a secondary coil of the isolation transformer.

The appliance may include a power supply that is configured to be electrically connected to an external power supply comprising a selected one of a 110 volt AC power supply and 220 volt AC power supply. The method may further include configuring the controller to generate an alert to a user interface of the appliance if the controller determines that an input voltage to the flyback converter indicates that the power supply of the appliance is not electrically connected to the selected one of a 110 volt AC power supply and a 220 volt AC power supply.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a diagram showing a flyback converter;

FIG. 2 is a chart showing electrical current and voltage for the flyback converter of FIG. 1;

FIG. 3 is a graph showing voltages for the flyback converter of FIG. 1;

FIG. 4 is a diagram of a flyback converter and sensing/detection circuit according to an aspect of the present disclosure;

FIG. 5 is a diagram of a flyback converter and sensing/detection circuit according to an aspect of the present disclosure, wherein the flyback converter includes multiple secondary coils and circuits;

FIG. 6A is an isometric view of a washer and dryer that may include a detection system according to an aspect of the present disclosure;

FIG. 6B is an isometric view of an oven that may include a detection system according to an aspect of the present disclosure;

FIG. 6C is an isometric view of a compact refrigerator that may include a detection system according to an aspect of the present disclosure;

FIG. 6D is an isometric view of a full size refrigerator that may include a detection system according to an aspect of the present disclosure;

FIG. 6E is a partially fragmentary isometric view of a range that may include a detection system according to an aspect of the present disclosure; and

FIG. 6F is an isometric view of a microwave oven that may include a detection system according to an aspect of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a flyback converter. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

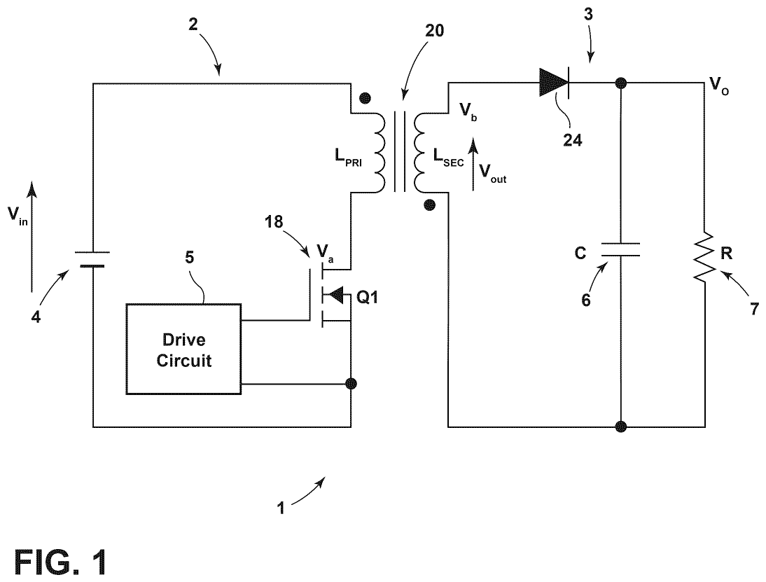

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

With reference to FIG. 1, a flyback converter 1 includes a primary circuit 2 that is coupled to an AC power source 4, a secondary circuit 3, and a transformer 20. As discussed in more detail below, the AC power source 4 may comprise, for example, a 110 volt AC power supply, a 220 volt AC power supply, or other suitable power supply. A drive circuit 5 may control a switch 18 of the primary circuit 2. Switch 18 may comprise a MOSFET or other suitable device. Secondary circuit 3 includes an output capacitor 6, an output load such as resistor 7, and power diode 24. It will be understood that the basic configuration of flyback converter 1 of FIG. 1 may be similar to known flyback converters.

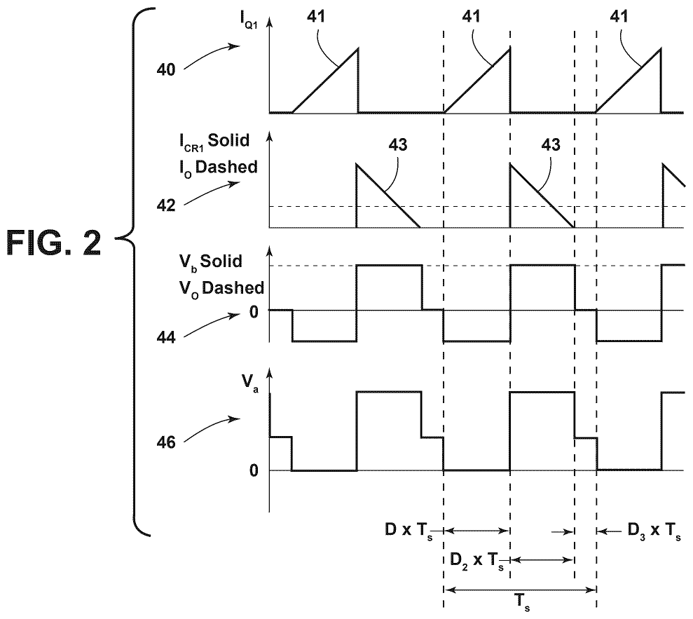

With further reference to FIG. 2, in use, the primary current 40 at switch 18 includes a plurality of increases 41 corresponding to the switch closed state, with zero current between the increases 41 corresponding to the switch open state. The secondary current 42 of secondary circuit 3 includes a plurality of increases 43, and the output voltage Vb and voltage Vo 44 are as shown in FIG. 2. Voltage Va 46 at switch 18 is also shown in FIG. 2. It will be understood that the currents and voltages of FIG. 2 may be similar to those of known flyback converters.

When switch 18 is closed (Ton), the following applies:
The output voltage of the secondary output is given by the formula Vb_on=−Vin×Ns/Np and Vo=0V
The secondary current is 0
The primary current is increasing to Ip

When the switch 18 is open (Toff) the following applies:
The output voltage of the secondary output is given by the formula Vb_off=Vor×Ns/Np, and Vo=Vb_off
The primary current is 0
The secondary current is linearly decreasing from a max value Is=Ip(Ns/Np) of down to 0 A.

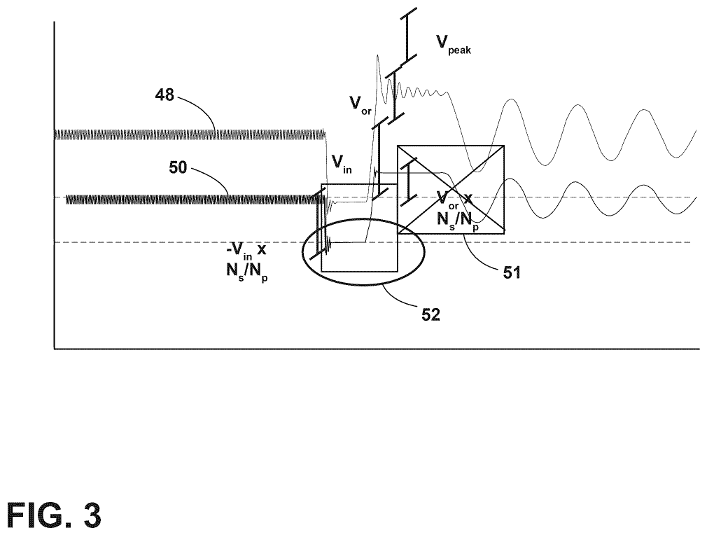

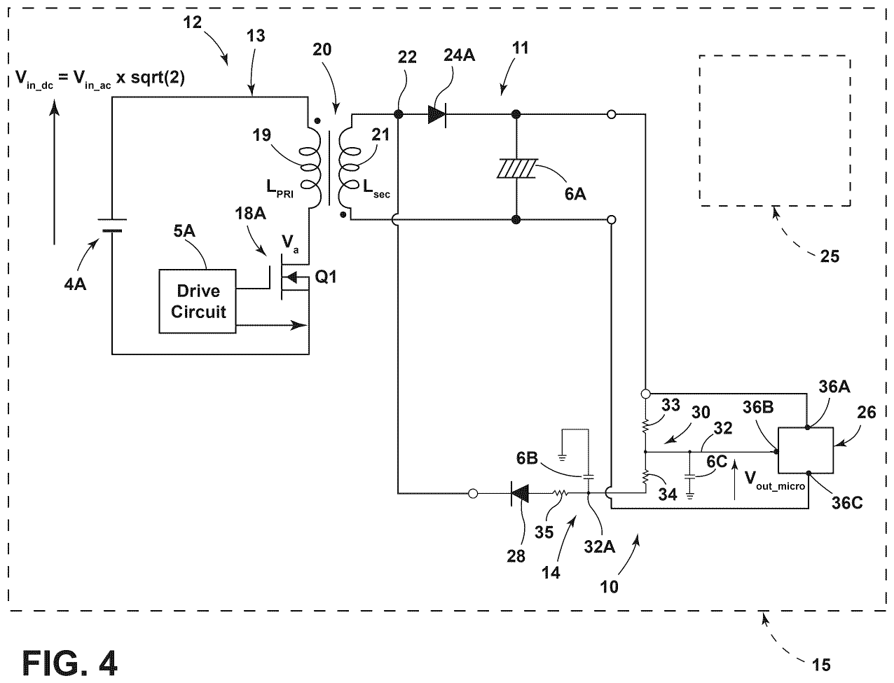

With further reference to FIG. 3, when the switch 18 is ON, the voltage drop 48 across switch 18 is 0, and the transformer output voltage 50 is equal to −Vin×Ns/Np. By measuring the Vout signal 50, a controller can measure the Vin_dc and Vin_ac. The Vout signal includes a positive part and a negative part. As discussed below in connection with FIG. 4, the positive portion of the Vout signal may be cancelled by a detection circuit 14 whereby only the negative portion of the Vout signal is read by a controller 26. The cancellation is shown schematically at 51 in FIG. 3, and the negative portion of the signal is generally shown at 52.

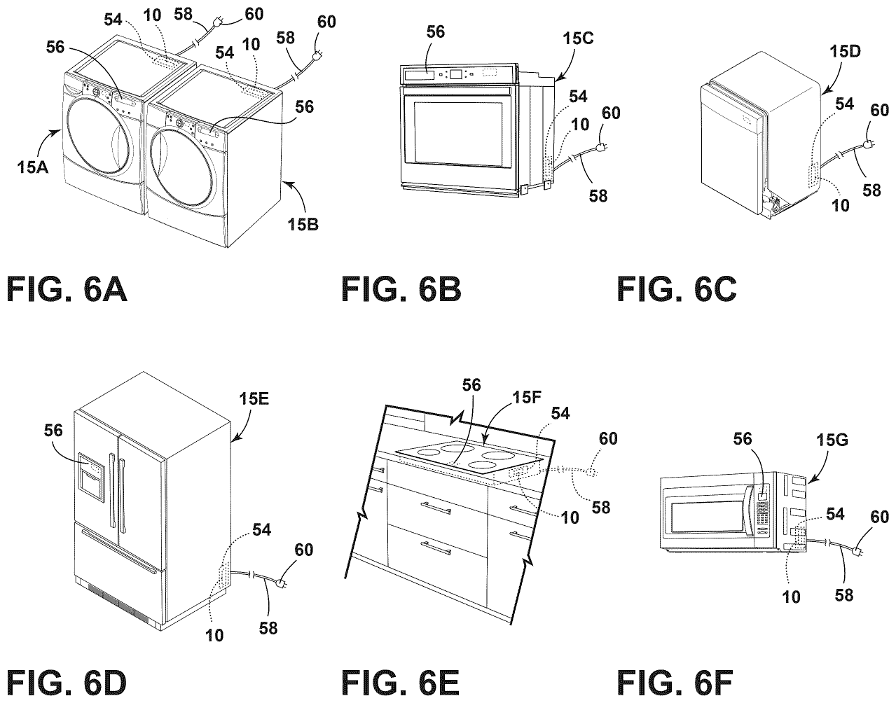

With further reference to FIG. 4, a detection/sensing system 10 for a power supply of an appliance 15 includes a flyback converter 12 that isolates a secondary circuit 11 from a primary circuit 13. The primary circuit 13 is powered by a main AC power supply 4A. Power supply 4A may comprise, for example electrical lines 58 and plugs 60 as discussed in more detail below in connection with FIGS. 6A-6F. The input voltage of main AC power supply 4A (Vin_ac) may be virtually any voltage. In general, Vin_ac may comprise the mains voltage and may range from, for example, 85V to 300V depending on the region. The input voltage of main AC power supply 4A (Vin_ac) may be virtually any voltage. In general, Vin_ac may comprise the mains voltage and may range from, for example, 85V to 300V depending on the region. The flyback converter 12 includes a switch 18A (e.g. a transistor) in series with a primary coil 19 of transformer 20. The switch 18A is selectively controlled by a drive circuit 5A to cause current to flow through the primary coil 19 at a target frequency. The primary coil 19 induces a current in a secondary coil 21 of the transformer 20. In general, the induced current in secondary coil 21 may be positive or negative. Flyback converter 12 may supply power to powered components 25 of appliance 15. As discussed in more detail below in connection with FIGS. 6A-6F, appliance 15 may comprise, for example, a washer and dryer 15A, 15B, respectively (FIG. 6A), an oven 15C (FIG. 6B), a compact refrigerator 15D (FIG. 6C), a refrigerator 15E (FIG. 6D), a range 15F (FIG. 6E), a microwave oven 15G (FIG. 6F), or other appliance.

When a positive current is induced in secondary coil 21 the positive current flows from a secondary node 22 through a power diode 24A to an input 36A of controller 26 to thereby power the controller 26. Electrical current from secondary coil 21 is supplied to input 36C of controller 26 to power controller 26. The voltage across inputs 36A and 36C of controller 26 may be 5 volts DC or virtually any other suitable power as may be required. In the example of FIG. 4, Vout_micro is given by the equation:

Vout_micro=Vout×(R1/(R1+R2))+VCC×(R2/(R1+R2))

Controller 26 may comprise a microcontroller or other suitable device or circuit that can be configured (e.g. programmed) to provide the desired warnings and/or other signals concerning AC power supply 4A. The power diode 24A acts as a rectifier to provide a positive voltage to the controller 26. Secondary circuit 11 includes an output capacitor 6A that supplies electrical energy to input 36B of controller 26 when switch 18A is closed (ON).

A detection circuit 14 includes a sensing diode 28 that is oriented opposite the power diode 24. Restated, the secondary node 22 is connected to the anode of the power diode 24 and the cathode of the sensing diode 28. A voltage divider 30 (resistors 33 and 34) is provided in series with sensing diode 28, and electrically interposes the sensing diode 28 and the controller 26. Capacitors 6B and 6C isolate the ground connections of nodes 32 and 32A. A sensing node 32 may be electrically connected between an input 36B of controller 26 and voltage divider 30. Voltage divider 30 conditions a detection signal flowing through a resistor 35 and the sensing diode 28 to allow the controller 26 to determine a state of the primary circuit 16. For example, when negative current is induced in secondary coil 21, controller 26 can read an analog voltage representative of the condition of the primary circuit 16.

In this way, controller 26 determines miswiring of the appliance 15 or changes in the AC power in response to the detection signal. For example, if appliance 15 is configured to be used with a 120V AC power source, and the appliance is incorrectly connected to a 240V AC power supply, controller 26 will detect the incorrect power supply and notify a user of the problem and/or modify operation of the appliance (e.g. shut down) to avoid damage to the appliance 15. Controller 26 may also be configured to modify operation if changes in the main voltage are detected. For example, if the main voltage begins to drop because a user has unplugged the appliance 15, controller 26 may store user settings and other information (e.g. a wash cycle information if appliance 15 comprises a washing machine) in memory so that the data can be retrieved when power is restored to the appliance.

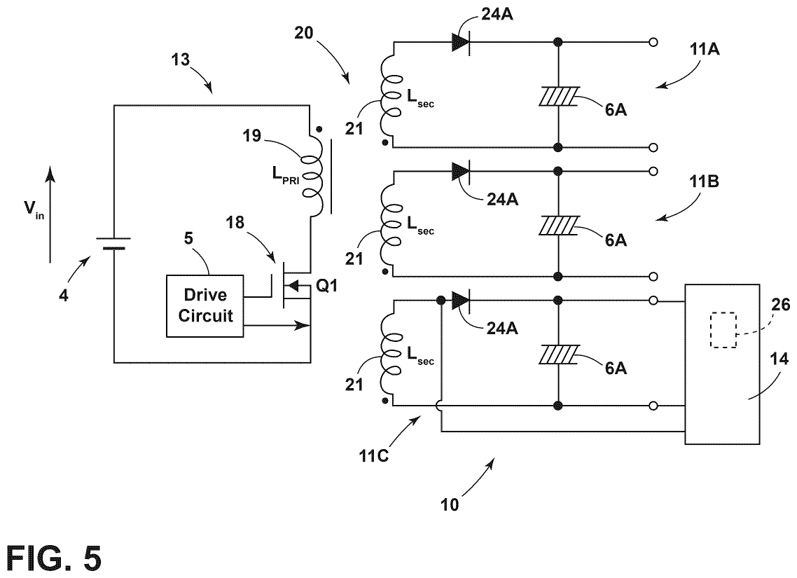

With further reference to FIG. 5, a primary circuit 13 may be utilized in connection with a plurality of secondary circuits 11A, 11B, and 11C. As discussed above, in general, detection circuit 14 utilizes the reflected voltage from the primary circuit 13. Because this voltage from the primary circuit 13 applies to all secondary coils 21, any one of the secondary coils 21 may be utilized as a source for the reflected voltage that is captured by detection circuit 14. In the example of FIG. 5, the detection circuit 14 is operably connected to a third secondary circuit 11C. However, it will be understood that the detection circuit 14 may be operably connected to any one of the secondary circuits 11A, 11B, 11C, etc.

With further reference to FIG. 6A, detection circuit 14 may be utilized in power supplies 54 of appliances such as washing machine 15A and/or dryer 15B. Washer 15A and dryer 15B may be configured to wash (launder) and dry clothing and other items. The detection system 10 (e.g. controller 26) may be operably connected to a user interfaces 56 of washer 15A and dryer 15B. The power supplies 54 may include electrical lines 58 having plugs 60 that are configured to be plugged into power receptacles to supply electrical power to the appliances 15A and 15B. Plugs 60 may comprise conventional plugs that are configured to electrically connect the appliances 15A and 15B to, for example a 110 volt AC receptacle, or a 220 volt AC receptacle. As discussed above, the detection system 10 may be configured to detect an improper power supply (e.g. miswiring). If, for example, the appliances 15A and 15B are configured to be connected to a 110 volt AC power supply, but are improperly connected to a 220 volt AC power supply, the detection system 10 may detect the miswiring, and cause the user interfaces 56 to alert a user utilizing text and/or audio and/or other suitable communication. The detection system 10 may optionally include a wireless communication capability whereby a signal can be sent to a smartphone or other device utilizing, for example, Bluetooth, Wi-Fi, or other suitable signal to thereby provide a remote alert of miswiring or other improper power supply.

With further reference to FIG. 6B, detection system 10 may also be incorporated into a power supply 54 of an appliance comprising an oven 15C. Oven 15C may include conductors such as an electrical line 58 and plug 60 that supply power to power supply 54. Oven 15C may include a user interface 56 that may be utilized to alert a user if detection system 10 detects miswiring or other problems associated with the power supply. The operation of the detection system 10 in the oven 15C may be substantially similar to the operation of the detection system 10 and the washer and dryer 15A and 15B of FIG. 6A, as described above.

With further reference to FIG. 6C, detection system 10 may be incorporated into a power supply 54 of an appliance comprising a compact refrigerator 15D. Compact refrigerator 15D includes an electrical line 58 and plug 60 that supply power to power supply 54. Compact refrigerator 15D may include a user interface 56 that may be utilized to alert a user if detection system 10 detects miswiring or other problems associated with the power supply. The operation of the detection system 10 in the compact refrigerator 15D may be substantially similar to the operation of the detection system 10 and the washer and dryer 15A and 15B of FIG. 6A, as described above.

With further reference to FIG. 6D, detection system 10 may be incorporated into a power supply 54 of an appliance comprising a full-size refrigerator 15E. full size refrigerator 15E includes an electrical line 58 and plug 60 that supply power to power supply 54. A full-size refrigerator 15E may include a user interface 56 that may be utilized to alert a user if detection system 10 detects miswiring or other problems associated with the power supply. The operation of the detection system 10 in the full-size refrigerator 15E may be substantially similar to the operation of the detection system 10 and the washer and dryer 15A and 15B as described above.

With further reference to FIG. 6E, detection system 10 may also be incorporated into a power supply 54 of an appliance comprising a range 15F. Range 15F optionally includes an electrical line 58 and plug 60 that supply power to power supply 54. Range 15F may include a user interface 56 that may be configured to alert a user if detection system 10 detects miswiring or other problems associated with the power supply. The operation of the detection system 10 in the range 15F may be substantially similar to the operation of the detection system 10 as described above in connection with other types of appliances.

With further reference to FIG. 6F, detection system 10 may be incorporated into a power supply 54 of an appliance comprising an microwave oven 15G. Microwave oven 15G may include an electrical line 58 and plug 60 that supply power to power supply 54. Microwave oven 15G may include a user interface 56 that may be utilized to alert a user if detection system 10 detects miswiring or other problems associated with the power supply. The operation of the detection system 10 in the microwave oven 15G may be substantially similar to the operation of the detection systems 10 in other types of appliances as described above.

It will be understood that the present disclosure is not limited to the specific detection system 10 described above in connection with FIG. 4. In general, the detection system 10 may comprise virtually any suitable circuit or device that is configured to detect voltage and/or current of a primary circuit 13 of a flyback converter 12 utilizing voltage and/or current of a secondary circuit 11. Furthermore, it will be understood that the detection system 10 does not necessarily need to include a microcontroller 26, but rather may utilize other suitable devices to detect unexpected or incorrect voltage and/or currents in a primary circuit of a flyback converter.

An aspect of the present disclosure is a detection system for a power supply of an appliance. The detection system includes a flyback converter, a detection circuit, and a controller. The flyback converter includes: 1) an isolation transformer, 2) a switch for controlling current through a primary coil of the isolation transformer, and 3) a power diode connected to a secondary coil of the isolation transformer at a secondary node to provide rectified power to the controller. The detection circuit includes a sensing diode having an orientation that is opposite an orientation of the power diode. The sensing diode electrically connects the secondary node with the controller to provide a detection signal to the controller.

The detection circuit may include a voltage divider interposing the sensing diode and the controller to condition the detection signal.

The controller may be configured to determine if the appliance is miswired based, at least in part, on the detection signal.

The controller may be configured to read an analog voltage if negative current is induced in the secondary coil of the isolation transformer to determine that the appliance is miswired.

The detection circuit may be configured to cancel a positive portion of a signal across the secondary coil of the isolation transformer whereby the controller reads only a positive portion of a signal across the secondary coil of the isolation transformer.

Another aspect of the present disclosure is a power supply including a flyback converter. The flyback converter includes an isolation transformer coupling a primary side defining an input voltage to a secondary side defining an output voltage. The primary side is configured to be coupled to an AC power source. The primary side may be operably connected to a drive circuit controlling a switch to cause the switch to change between ON and OFF states, thereby causing current to flow through a primary coil of the transformer at a target frequency, and causing positive and negative output current and output voltage in a secondary coil of the transformer on the secondary side. The power supply includes a controller that is operably coupled to first and second nodes of the secondary coil by first and second lines, respectively. The first line includes a power diode whereby positive voltage is supplied to the controller. The power supply further includes an output capacitor interconnecting the first and second lines. A detection circuit operably interconnects the controller to the secondary coil. The detection circuit includes a sensing diode having an orientation that is opposite an orientation of the power diode. The sending diode electrically connects the first node with the controller to provide a detection signal to the controller.

The detection circuit may include a voltage divider interposing the sensing diode and the controller to condition the detection signal.

The controller may be configured to determine if the appliance is miswired based, at least in part, on the detection signal.

The controller may be configured to read an analog voltage if negative current is induced in the secondary coil of the isolation transformer to determine that the appliance is miswired.

The detection circuit may cancel a positive portion of a signal across the secondary coil of the isolation transformer, whereby the controller reads only a positive portion of a signal across the secondary coil of the isolation transformer.

Another aspect of the present disclosure is a method of measuring a AC input voltage to a flyback converter of a power supply of an appliance utilizing a detection circuit. The method includes operably coupling a power diode to a secondary coil of an isolation transformer of the flyback converter at a secondary node to provide rectified power to a controller. A sensing diode is operably coupled with the secondary node and with the controller, wherein the sensing diode is coupled in an orientation that is opposite an orientation of the power diode, whereby the sensing diode provides a detection signal to the controller. The method further includes causing the controller to read the AC input voltage utilizing the detection signal.

The detection circuit may further include a voltage divider interposing the sensing diode and the controller. The method may include conditioning the detection signal utilizing the voltage divider.

The method may include configuring the controller to determine if the appliance is miswired based, at least in part, on the detection signal.

The method may include configuring the controller to read an analog voltage if negative current is induced in the secondary coil of the isolation transformer to determine that the appliance is miswired.

The method may further include utilizing the detection circuit to cancel a positive portion of a signal across the secondary coil of the isolation transformer whereby the controller reads only a positive portion of a signal across the secondary coil of the isolation transformer.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A detection system for a power supply of an appliance, the detection system comprising:
a flyback converter;
a detection circuit;
a controller;
and wherein the flyback converter includes: 1) an isolation transformer, 2) a switch for controlling current through a primary coil of the isolation transformer, and 3) a power diode connected to a secondary coil of the isolation transformer at a secondary node to provide rectified power to the controller;
and wherein the detection circuit includes a sensing diode having an orientation that is opposite an orientation of the power diode, and wherein the sensing diode electrically connects the secondary node with the controller to provide a detection signal to the controller.

2. The detection system of claim 1, wherein:
the detection circuit further includes a voltage divider interposing the sensing diode and the controller to condition the detection signal.

3. The detection system of claim 2, wherein:
the controller is configured to determine if the appliance is miswired based, at least in part, on the detection signal.

4. The detection system of claim 3, wherein:
the controller is configured to read an analog voltage if negative current is induced in the secondary coil of the isolation transformer to determine that the appliance is miswired.

5. The detection system of claim 4, wherein:
the detection circuit cancels a positive portion of a signal across the secondary coil of the isolation transformer whereby the controller reads only a positive portion of a signal across the secondary coil of the isolation transformer.

6. An appliance including the detection system of claim 1, wherein:
the appliance includes a housing and an electrical power system disposed inside the housing, and an electrical line having a plug that is configured to engage an electrical socket to electrically connect the electrical power system to a selected one of a 110 volt AC power system and a 220 volt AC power system.

7. The appliance of claim 6, wherein:
the flyback converter includes a primary side that is electrically coupled to a secondary side by the isolation transformer, wherein the primary side is configured to be coupled to a selected one of a 110 volt AC power system and a 220 volt AC power system;
the controller comprises a microcontroller; and:
the flyback converter is configured to supply the microcontroller with 5 volt DC electrical power.

8. The appliance of claim 7, wherein:
the microcontroller is operably coupled to a user interface of the appliance;
the microcontroller is configured to cause the user interface to provide an audio and/or visual indication that the appliance is miswired if the microcontroller determines that the electrical power system is not electrically connected to the selected one of a 110 volt AC power system and a 220 volt AC power system as required for proper operation of the appliance.

9. The appliance of claim 6, wherein:
the appliance is selected from the group consisting of: a washing machine for laundering clothes, a clothes dryer, an oven having an electrical heating element, a microwave oven, and a range that is configured to heat cooking utensils.

10. A power supply comprising:
a flyback converter including an isolation transformer coupling a primary side defining an input voltage to a secondary side defining an output voltage, wherein the primary side is configured to be coupled to an AC power source, and wherein the primary side is operably connected to a drive circuit controlling a switch to cause the switch to change between ON and OFF states, thereby causing current to flow through a primary coil of the transformer at a target frequency and causing positive and negative output current and output voltage in a secondary coil of the transformer on the secondary side;
a controller operably coupled to first and second nodes of the secondary coil by first and second lines, respectively;
wherein the first line includes a power diode whereby positive voltage is supplied to the controller;
an output capacitor interconnecting the first and second lines;
a detection circuit operably interconnecting the controller to the secondary coil, the detection circuit including a sensing diode having an orientation that is opposite an orientation of the power diode, and wherein the sensing diode electrically connects the first node with the controller to provide a detection signal to the controller.

11. The power supply of claim 10, wherein:
the detection circuit further includes a voltage divider interposing the sensing diode and the controller to condition the detection signal.

12. The power supply of claim 11, wherein:
the controller is configured to determine if the appliance is miswired based, at least in part, on the detection signal.

13. The power supply of claim 12, wherein:
the controller is configured to read an analog voltage if negative current is induced in the secondary coil of the isolation transformer to thereby determine that the appliance is miswired.

14. The power supply of claim 13, wherein:
the detection circuit cancels a positive portion of a signal across the secondary coil of the isolation transformer whereby the controller reads only a positive portion of a signal across the secondary coil of the isolation transformer.

15. A method of measuring an AC input voltage to a flyback converter of a power supply of an appliance utilizing a detection circuit, the method comprising:
operably coupling a power diode to a secondary coil of an isolation transformer of the flyback converter at a secondary node to provide rectified power to a controller;
operably coupling a sensing diode with the secondary node and with the controller, wherein the sensing diode is coupled in an orientation that is opposite an orientation of the power diode, whereby the sensing diode provides a detection signal to the controller; and:
causing the controller to read the AC input voltage utilizing the detection signal.

16. The method of claim 15, wherein:
the detection circuit further includes a voltage divider interposing the sensing diode and the controller; and including:
conditioning the detection signal utilizing the voltage divider.

17. The method of claim 16, including:
configuring the controller to determine if the appliance is miswired based, at least in part, on the detection signal.

18. The method of claim 17, including:
configuring the controller to read an analog voltage if negative current is induced in the secondary coil of the isolation transformer to determine that the appliance is miswired.

19. The method of claim 18, including:
utilizing the detection circuit to cancel a positive portion of a signal across the secondary coil of the isolation transformer whereby the controller reads only a positive portion of a signal across the secondary coil of the isolation transformer.

20. The method of claim 15, wherein:
the appliance includes a power supply that is configured to be electrically connected to an external power supply comprising a selected one of a 110 volt AC power supply and a 220 volt AC power supply; and including:
configuring the controller to generate an alert to a user interface of the appliance if the controller determines that an input voltage to the flyback converter indicates that the power supply of the appliance is not electrically connected to the selected one of a 110 volt AC power supply and a 220 volt AC power supply.
